(19) United States
(12) Patent Application Publication
(10) Pub. No.: US 2017/0166257 A1
(43) Pub. Date: Jun. 15, 2017

(54) VEHICLE BODY WITH ROOFING

(71) Applicant: GM GLOBAL TECHNOLOGY OPERATIONS LLC, Detroit, MI (US)

(72) Inventor: Matthias HALLIK, Ruesselsheim (DE)

(73) Assignee: GM GLOBAL TECHNOLOGY OPERATIONS LLC, Detroit, MI (US)

(21) Appl. No.: 15/378,326

(22) Filed: Dec. 14, 2016

(30) Foreign Application Priority Data
Dec. 14, 2015 (DE) 102015016209.8

(51) Int. Cl. B62D 25/06; B60R 9/04; B60J 5/10

(52) U.S. Cl. CPC B62D 25/06; B60J 5/101; B60R 9/04

(57) ABSTRACT

A motor vehicle body has a roof surface which is delimited towards the back by a tailgate and laterally by a roof channel. An upper edge of the tailgate and a rear edge of the roof channel jointly delimit an opening which is directed towards the front. A roof rail is arranged in the roof channel and the distance between the upper edge and a rear flank of the roof rail is less than the height of the opening.

### CROSS REFERENCE TO RELATED APPLICATION

This application claims priority to German Patent Application No. 102015016209.8 filed Dec. 14, 2015, which is incorporated herein by reference in its entirety.

### TECHNICAL FIELD

The present disclosure pertains to a motor vehicle body, in the case of which a roof surface is laterally delimited by a roof channel and a roof rail arranged in the roof channel.

### BACKGROUND

Conventionally, roof rails exclusively serve as anchorage for a roof load carrier and accordingly are primarily configured under aspects of utility. Recently, roof rails have also been used in a creative or decorative manner, in particular, in the case of body shapes of relatively high height as for example in the case of a station wagon or an SUV, can serve to conceal an arch of the vehicle roof and give an observer the impression of being flatter than it actually is. This goes so far that in the case of some vehicle types the roof rail has entirely lost its original anchorage function for the roof load carrier and merely serves for creative purposes.

In order for the roof rail to be able to conceal an arched roof, it should be fastened as closely as possible to a lower edge of the roof. As a result, the roof channel which conventionally extends on the lateral edge of the roof above the doors of the passenger compartment in order to drain water from the door apertures was widened in order to also mount the roof rail therein.

In order for the rain to drain from the roof channel, the same has to extend as far as to a rear edge of the roof surface. The roof rail, which is deep-drawn out of metal, is tapered or flattened wedge-like at its ends for production reasons and does not reach as far as to the rear end of the roof channel. When a tailgate is attached at the rear edge of the roof surface in extension of the same, the tailgate also has to have an indentation corresponding to the cross section of the gutter at its upper edge in order to avoid severe wind noises by the airstream. This indentation increases the effort during the production of the tailgate and additionally is not aesthetically pleasing.

### SUMMARY

According to the present disclosure, a vehicle body is provided in which the wind noises on an upper edge of a tailgate can be avoided without the course of the upper edge having to be adapted to the cross section of a roof channel running towards the tailgate.

According to a configuration of the present disclosure, a motor vehicle body has a roof surface, which is limited rearwardly in the longitudinal direction of the vehicle by a tailgate and laterally by a roof channel. An upper edge of the tailgate and a rear edge of the roof channel jointly define a forward opening. A roof rail is arranged in the roof channel and the distance between the upper edge and a rear flank of the roof rail is less than the height of the opening. Therefore, the upper edge of the tailgate does not have to be adapted to the cross-section of the roof channel, in order to avoid a forward opening in which the traveling wind catches. Instead, the existence of the opening is acceptable because the roof rail is so close to the opening that it blocks, if not completely at least in large part, the cross section of the opening and thus prevents the generation of wind noises at the opening.

In order to effectively block the opening, the rear flank of the roof rail should have an inclination of more than 45° against the horizontal. The inclination of the flank should approximately coincide with a plane defined by the upper edge of the tailgate and the rear edge of the roof channel, preferentially the deviation should not be greater than approximately 15°.

Furthermore, it is practical when the crown surface of the roof rail is flush with the upper edge of the tailgate for minimizing wind noise and wind resistance.

At least one end portion of the roof rail enclosing the rear flank is preferably molded from plastic in order to avoid restrictions of the design, which result when forming sheet metal. In particular, the entire roof rail can be unitarily molded from plastic. This is practical, in particular, when the roof rail only serves for creative purposes and no longer functions as substructure for a roof load carrier.

Alternatively, the end portion can be plug-connected to a main part of the roof rail. Then, the main part can be formed in particular from sheet metal and have the load capacity needed for a substructure of a roof load carrier. In order to close off the opening over as large as possible an area, the end portion can be wider than a main part of the roof rail.

A panel forming the roof surface and a sidewall panel can be connected to one another in the roof channel.

A connection between the panel forming the roof surface and the sidewall panel can be concealed by the roof rail itself. However, even when the roof rail does not conceal the connection but projects upwards from the panel forming the roof surface adjacent to the roof rail, it can effectively conceal the same.

Preferably, the roof rail is continuous along the entire length of the roof channel.

The roof rail can be formed as hollow body, in particular in the form of a gutter that is open towards the bottom or a pipe that is closed off at the ends.

If the roof rail serves merely for design purposes and is not intended to be loaded with a roof load carrier, attempts to mount a roof load carrier can be preempted by forming the roof rail with an upwardly narrowing cross-section such that a retaining claw of a roof load carrier slides off.

### BRIEF DESCRIPTION OF THE DRAWINGS

The present disclosure will hereinafter be described in conjunction with the following drawing figures, wherein like numerals denote like elements.

FIG. 1 is a perspective view of a rear corner of the roof surface of a motor vehicle body according to the present disclosure;

FIG. 2 is a longitudinal section through the boundary region between roof surface and tailgate of the motor vehicle body;

FIG. 3 is an enlarged detail from FIG. 2;

FIG. 4 is a cross section through a lateral edge region of the roof surface; and

FIG. 5 is a perspective view that is analogous to FIG. 1 according to a second configuration of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

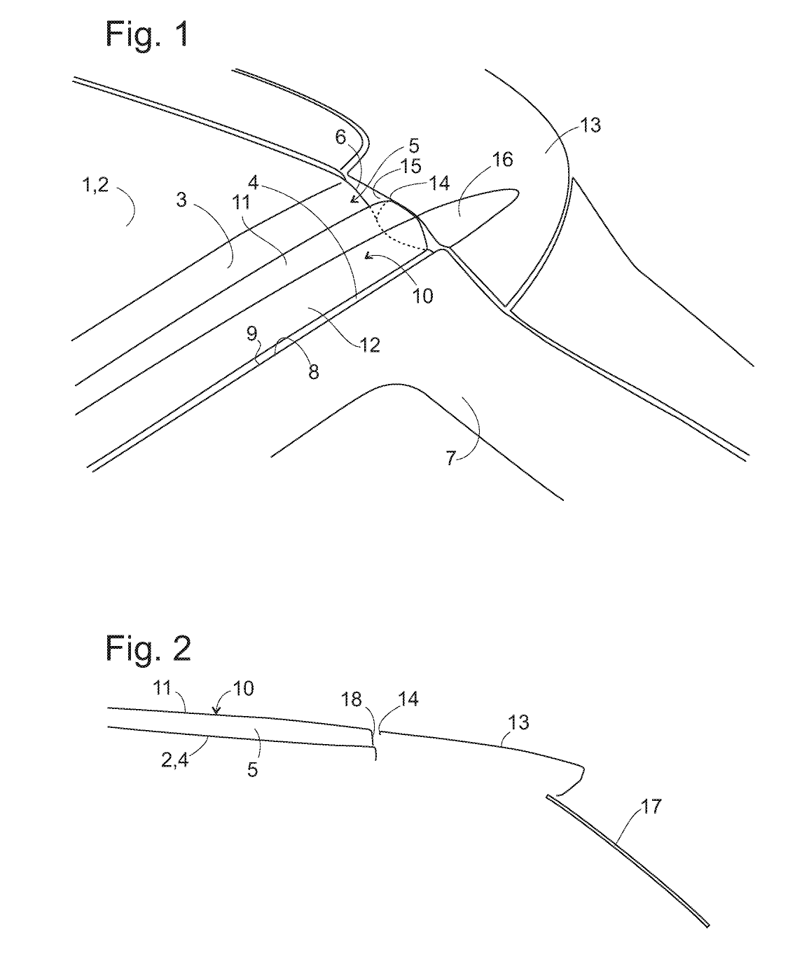

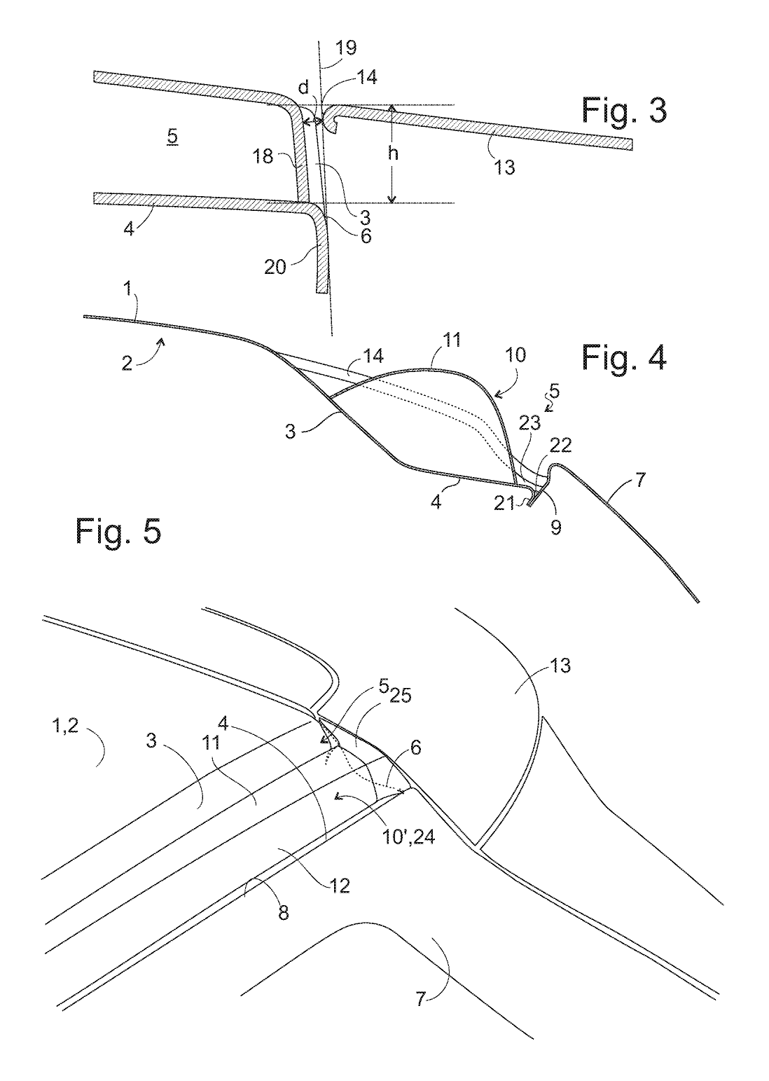

In a perspective view, FIG. 1 shows a left rear corner of the passenger compartment of a motor vehicle body as seen in travelling direction. A roof surface 1 of the passenger compartment is substantially formed by a unitary roof panel 2. Lateral edge regions of the roof panel 2 each form a sidewall 3 and a bottom 4 of a roof channel 5, which extends on both sides of the roof surface 1 over its entire length, from a front edge following the upper edge of a windshield, which is not shown in the figure, to a rear edge 6. Along the rear edge 6, a narrow flange is angled into the vehicle interior in order to stiffen the roof panel 2. This flange is not visible in FIG. 1, while in FIG. 3 it is marked with 20.

A sidewall panel 7 of the body extends above a side window aperture which is partly shown in FIG. 1 and a door aperture which is not shown. The sidewall panel 7 is bent over along an apex line 8 in order to form a second sidewall 9 of the roof channel 5 that is concealed in FIG. 1.

A tailgate 13 follows flush on a middle region of the rear edge extending between the two roof channels 5 and the sidewall panel 7. At the ends of the roof channels 5, the course of an upper edge 14 of the tailgate 13 deviates from that of the sidewalls 3, 9 and of the bottom 4, so that the upper edge 14 and rear edges of the sidewalls 3, 9 and of the bottom 4 form an opening 15 facing the airstream.

On the bottom 4 of the roof channel 5, a roof rail 10 is anchored. The roof rail 10 in this case is a molded body made from plastic which unitarily extends over substantially the entire length of the roof channel 5. Preferably, the roof rail 10 is formed as hollow body in the form of a gutter, the open side of which faces the bottom 4 and the longitudinal walls 12 (see FIG. 4) on both sides of the open side tightly lie against the bottom 4. Such a hollow body can be obtained in particular by deep-drawing flat material or by injection molding. In order to facilitate the anchorage in the roof channel 5, the roof rail 10 can also be designed tubular, with a wall lying flat against the bottom 4. An crown surface 11 of the roof rail 10 continuously extends at the same distance from the bottom 4 as far as to immediately to the rear edge 6, so that a rear flank 18 of the roof rail 10 facing away from the observer in FIG. 1 closes off the opening 15 over a large part of its cross section.

Remnants of the opening 15 right and left of the roof rail 10 may be exposed since the small dimensions do not significantly contribute to the wind noise. If desired, the cross section of such a remaining opening as is visible in FIG. 1 on the side of the roof rail 10 adjacent to the sidewall panel 7, can be further reduced in that next to the roof rail 10, a small-size indentation 16 is formed in the tailgate 13.

FIG. 2 shows a schematic longitudinal section through the roof of the vehicle body along a section plane running in longitudinal direction of the roof channel 5 through the roof rail 10. Visible are the bottom 4 of the roof channel 5, the crown surface 11 of the roof rail 10 and the tailgate 13 located opposite these with a rear window 17. As is clearly noticeable in particular in the enlarged representation of FIG. 3, the roof rail 10 terminates at its rear end with a steeply dropping flank 18 which is orientated approximately parallel to a plane 19 running through the upper edge 14 of the tailgate 13 and the rear edge 6 of the bottom 4. The distance d between the flank 18 and the upper edge 14, measured along a surface normal of the flank 18, is clearly smaller than the height h of the opening 15, so that the airstream through the roof rail 10 is effectively prevented from breaking on the upper edge 14 and forming noise-intensive turbulences.

FIG. 4 shows a section in vehicle transverse direction through the roof channel 5. The section plane lies in vehicle longitudinal direction in front of the rear edge 6; since the bottom 4 and the crown surface 11 of the roof rail 10 drop parallel to one another towards the back, the crown surface 11 in the section plane lies higher than the upper edge 14 of the tailgate 13. The longitudinal walls 12 of the roof rail 10 are convergent over their entire height from their lower edge lying against the bottom 4 towards the top, towards the crown surface, so that the assembly of a roof carrier by clamping-on or form-fit mounting on the roof rail 10 is excluded.

Here it is evident that bottom 4 and sidewall 3 of the roof channel 5 are unitary constituent parts of the roof panel 2, at an outer edge of the bottom 4 a flange 21 is angled downwards and bonded or welded to the lower edge of the sidewall 9 angled from the sidewall panel 7. The connection 22 between the roof panel 2 and the sidewall panel 7 is located at the lowest point of a groove 23, which on the one hand is delimited by the sidewall 9 and on the other hand by the roof rail 10 and is therefore visible only at a narrowly limited angle of vision, steeply from above.

According to a modification, the connection between roof panel and sidewall panel may be entirely concealed in that it is placed in the middle of the roof channel, under the roof rail.

FIG. 5 shows a further modification of the present disclosure in a perspective view from the same viewing direction as in FIG. 1. Roof panel 2 and sidewall panel 7 do not differ from those shown in FIGS. 1 to 4, the differences are limited to the roof rail here marked with 10′. The roof rail 10′ is constructed from multiple parts; a main part 24 of it has a cross section that is invariable over its length and can be produced for example as extruded profile from plastic or metal. An end section 25 is connected to the rear end of the main part 24, for example by plugging a spigot of the end section 25 into a hollow space of the main part 24. The end section 25 is expanded towards the back so that it closes off the opening 15 over its entire extent.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A motor vehicle body comprising:
a roof surface having a longitudinally extending roof channel formed therein;
a tailgate disposed adjacent the roof surface such that an upper edge of the tailgate and an rear edge of the roof channel jointly define a forward opening having a height above the roof channel;
a roof rail arranged in the roof channel and having a rear flank, wherein a distance between the upper edge of the tailgate and the rear flank of the roof rail is less than the height of the opening.

16. The motor vehicle body according to claim 15, wherein the rear flank has an inclination of greater more than 45° against the horizontal.

17. The motor vehicle body according to claim 15, wherein the upper edge of the tailgate and the rear edge of the roof channel define a plane inclined no more than 15° with respect to the rear flank.

18. The motor vehicle body according to claim 15, wherein a crown surface of the roof rail is flush with the upper edge.

19. The motor vehicle body according to claim 15, wherein at least one end section of the roof rail enclosing the rear flank is molded from plastic.

20. The motor vehicle body according to claim 20, wherein the roof rail comprises a unitary roof rail.

21. The motor vehicle body according to claim 20, wherein the roof rail comprises a main rail section and an end section is plug-connected to the main rail section.

22. The motor vehicle body according to claim 21, wherein the end section is wider than the main rail section.

23. The motor vehicle body according to claim 15, further comprising a panel forming the roof surface and a sidewall panel in the roof channel form a joint therebetween.

24. The motor vehicle body according to claim 23, wherein the joint between the panel and the sidewall panel is concealed by the roof rail.

25. The motor vehicle body according to claim 23, wherein the roof rail projects from the panel forming the roof surface adjacent to the joint between the panel and the sidewall panel.

26. The motor vehicle body according to claim 15, wherein the roof rail lies against a bottom of the roof channel over its entire length.

27. The motor vehicle body according to claim 15, wherein the roof rail comprises a hollow body.

28. The motor vehicle body according to claim 27, wherein the roof rail has a cross section narrowing towards the top.
